(19) United States
(12) Patent Application Publication
(10) Pub. No.: US 2022/0048570 A1
(43) Pub. Date: Feb. 17, 2022

(54) FRONT STRUCTURE OF VEHICLE BODY

(71) Applicants: Hyundai Motor Company, Seoul (KR); Kia Motors Corporation, Seoul (KR)

(72) Inventor: Byung Gyu KIM, Uiwang-Si (KR)

(73) Assignees: Hyundai Motor Company, Seoul (KR); Kia Motors Corporation, Seoul (KR)

(21) Appl. No.: 17/192,685

(22) Filed: Mar. 4, 2021

(30) Foreign Application Priority Data
Aug. 13, 2020 (KR) 10-2020-0101493

(51) Int. Cl. B62D 21/15; B62D 25/08; B60R 19/26

(52) U.S. Cl. CPC B62D 21/155; B60R 2019/247; B60R 19/26; B62D 25/084

(57) ABSTRACT

A front structure of a vehicle body may include a sub-frame mounted on a front side member through a mounting plate, a lower crush box connected to each front end portion of the sub-frame along the vehicle body length direction thereof, a radiator support lower member connected to the lower crush box along the width direction of the vehicle, and a lower stiffener connected to the front end portion of the lower crush box along the width direction of the vehicle.

### CROSS-REFERENCE TO RELATED APPLICATION

The present application claims priority to Korean Patent Application No. 10-2020-0101493 filed on Aug. 13, 2020, the entire contents of which is incorporated herein for all purposes by this reference.

### BACKGROUND OF THE INVENTION

### Field of the Invention

The present invention relates to a front structure of a vehicle body. More particularly, the present invention relates to front structure of a vehicle body applicable to a light vehicle with a short overhang design.

### Description of Related Art

In general, when the vehicle body is basically small, such as a light/small vehicle, a short overhang design is adopted to secure an indoor space. Light/small vehicles with such a short overhang design may ensure not only external changes, but also vehicle movement performance and rotation stability.

However, the short overhang design of a light/small vehicle has a relatively narrow crush zone that absorbs the impact caused by a collision and reduces the impact transmitted to the occupant, so it may cause serious injury to the occupant during a collision.

To improve this, conventionally, as an example, a sub-frame having a lateral direction member is mounted on the front side of a vehicle body, and a front end module (FEM) is configured or a radiator support member is configured on the front side thereof.

However, conventionally, as a structure for securing the frontal collision safety of the vehicle is applied as described above, the space in the engine compartment becomes narrow, and weight and cost may increase according to the change of the sub-frame type.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a front structure of a vehicle body which may reduce weight and cost with a simple configuration in the vehicle body of a short overhang compact/small vehicle, and secure frontal collision safety.

A front structure of a vehicle body according to various exemplary embodiments of the present invention, the front structure may include a sub-frame mounted on a front side member through a mounting plate, a lower crush box connected to each front end portion of the sub-frame along the vehicle body length direction thereof, a radiator support lower member connected to the lower crush box along the width direction of the vehicle, and a lower stiffener connected to the front end portion of the lower crush box along the vehicle width direction thereof.

The sub-frame may include a frame main body connected to the rear portion of the front side member, and a longitudinal member connected to each front portion of the frame main body, and connected to a front portion of the front side member.

At the front portion of the front side member, the mounting plate may be connected along the up and down directions, and the front portion of the longitudinal member may be connected to the lower portion of the mounting plate.

The lower crush box may be connected to the front portion of the longitudinal member along the vehicle body length direction through a stay bracket.

The stay bracket may be connected to the front portion of the longitudinal member through a stay mounting portion.

The radiator support lower member may include a connecting flange portion connected to the lower crush box at both end portions along the width direction of the vehicle.

The lower stiffener may be connected to a mount groove formed at the front portion of the lower crush box.

The lower stiffener, the lower crush box and the sub-frame may be connected to each other along the vehicle body length direction.

The front structure according to various exemplary embodiments of the present invention may further include a back beam connected to a front portion of the front side member along the width direction of the vehicle through an upper crush box.

The front structure according to various exemplary embodiments of the present invention may include a first load path that connects the back beam and the front side member through the upper crush box, a second load path that connects the lower stiffener and the sub-frame through the lower crush box, and a third load path that connects the first load path and the second load path in up and down directions of the vehicle body through the mounting plate connected to the front portion of the front side member.

A front structure of a vehicle body according to various exemplary embodiments of the present invention may include a front side member provided on both sides in the length direction of the vehicle body, mounting plates, wherein an upper portion of each mounting plate is connected to the front portion of each front side member, a back beam connected to the mounting plates on both sides, a sub-frame including a frame main body which is connected to a rear portion of each front side member and longitudinal members provided on both front portions of the frame main body and connected to the lower portion of each mounting plate, a lower crush box connected to both front portions of the sub-frame, and a radiator support lower member connected to each of the lower crush boxes.

The front structure according to various exemplary embodiments of the present invention may further include a lower stiffener which is connected to each of the lower crush boxes.

The front structure of a vehicle body according to various exemplary embodiments of the present invention may be applied to the vehicle body of a short overhang compact/small vehicle.

Various exemplary embodiments of the present invention may effectively disperse collision energy through load paths in several directions in the vehicle body of a short overhang compact/small vehicle, and secure frontal collision safety.

Furthermore, the effect obtained or predicted by various exemplary embodiments of the present invention will be included directly or implicitly in the detailed description of various exemplary embodiments of the present invention. That is, various effects predicted according to various exemplary embodiments of the present invention will be included within a detailed description to be described later.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view showing a front structure of a vehicle body according to various exemplary embodiments of the present invention.

FIG. 2 is an exploded perspective view showing the front structure of a vehicle body according to various exemplary embodiments of the present invention.

FIG. 3 is a side view showing a front structure of a vehicle body according to various exemplary embodiments of the present invention.

FIG. 4 is a drawing showing a lower crush box applicable to a front structure of a vehicle body according to various exemplary embodiments of the present invention.

FIG. 5 and FIG. 6 is a drawing showing the connecting structure of a radiator support lower member applicable to a front structure of a vehicle body according to various exemplary embodiments of the present invention.

FIG. 7 is a drawing showing the connecting structure of a lower stiffener applicable to a front structure of a vehicle body according to various exemplary embodiments of the present invention.

FIG. 8 is a drawing showing the connecting structure of a back beam applicable to a front structure of a vehicle body according to various exemplary embodiments of the present invention.

FIG. 9 is an enlarged view of a part A of FIG. 8.

It may be understood that the appended drawings are not necessarily to scale, presenting a somewhat simplified representation of various features illustrative of the basic principles of the invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments of the present invention, it will be understood that the present description is not intended to limit the invention(s) to those exemplary embodiments. On the other hand, the invention(s) is/are intended to cover not only the exemplary embodiments of the present invention, but also various alternatives, modifications, equivalents and other embodiments, which may be included within the spirit and scope of the invention as defined by the appended claims.

Hereinafter, various Exemplary embodiments of the present application will be described more fully hereinafter with reference to the accompanying drawings, in which exemplary embodiment of the invention are shown. As those skilled in the art would realize, the described embodiments may be modified in various different ways, all without departing from the spirit or scope of the present invention.

To clearly describe the present invention, parts irrelevant to the description are omitted, and the same reference numerals are assigned to the same or similar components throughout the specification.

Since the size and thickness of each component shown in the drawings are arbitrarily shown for convenience of description, the present invention is not necessarily limited to those shown in the drawings, and the thickness is enlarged to clearly express various parts and regions.

Furthermore, in the following detailed description, the name of the configuration includes first, second, etc. To distinguish the configuration by the same relationship, and in the following description, the order is not necessarily limited.

In the entire specification, when a certain portion includes a certain constituent element, this means that other constituent elements may be further included rather than excluding other constituent elements unless otherwise specified.

Furthermore, terms such as. unit,. means, etc. described in the specification mean a unit of a comprehensive configuration that performs at least one function or operation.

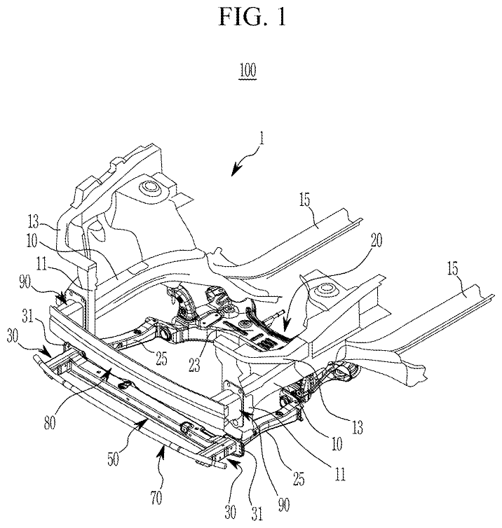

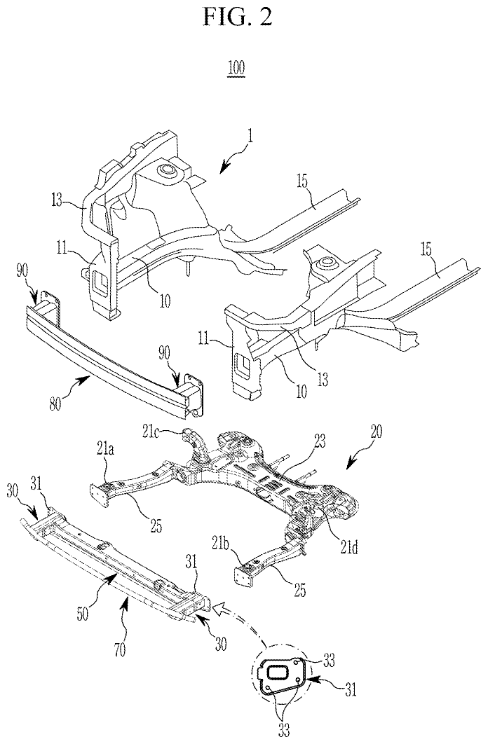

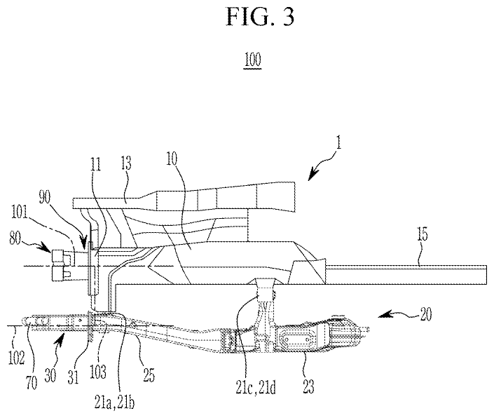

FIG. 1 is a perspective view showing a front structure of a vehicle body according to various exemplary embodiments of the present invention, FIG. 2 is an exploded perspective view showing the front structure of a vehicle body according to various exemplary embodiments of the present invention, and FIG. 3 is a side view showing a front structure of a vehicle body according to various exemplary embodiments of the present invention.

Referring to FIG. 1 to FIG. 3, a front structure 100 of a vehicle body 1 according to various exemplary embodiments of the present invention may be applied to the front structure of a vehicle on which a front suspension is mounted. Furthermore, the front structure 100 may be applied to the front structure of light/small vehicles, which is increasing in demand in domestic and global emerging markets.

Furthermore, the front structure 100 according to various exemplary embodiments of the present invention may be applied to the vehicle body 1 of a short overhang type light/small vehicle which may secure vehicle movement performance or rotation stability by extending the distance between axes.

Here, the front structure 100 may support the engine, transmission, chassis parts, etc. At the lower front side of the vehicle body 1.

In the industry, the width direction of the vehicle is called L direction thereof, the front and rear direction of the vehicle body is called the T direction thereof, and the height direction of the vehicle body is called H direction thereof. However, in various exemplary embodiments of the present invention, instead of setting the LTH direction as described above as the reference direction thereof, the constituent elements in the following will be described by setting the width direction of the vehicle, vehicle body length direction and up and down direction thereof.

Furthermore, the end (one/one end or the other/one end) in the following may be defined as either end, and a certain part (one/one end or the other/one end) including the end.

The front structure 100 of a vehicle body 1 according to various exemplary embodiments of the present invention is a simple configuration in the vehicle body of a short overhang compact/small vehicle, and has a structure which may reduce weight and cost and secure frontal collision safety.

For this, front structure 100 of a vehicle body 1 according to various exemplary embodiments of the present invention basically includes a sub-frame 20, a lower crush box 30, a radiator support lower member 50, a lower stiffener 70, and a back beam 80.

In various exemplary embodiments of the present invention, the sub-frame 20 may prevent the engine or transmission from being moved to the vehicle inside while appropriately separating from the vehicle body by receiving a collision load from the vehicle body when a vehicle collision occurs.

The sub-frame 20 is mounted through a mounting plate 11 on both front sides of a front side member 10 from the front and lower side of vehicle body 1. The sub-frame 20 is mounted on the lower side of the front side and the rear side of the front side member 10.

Here, the mounting plate 11 is coupled to the front end portion of the front side member 10 in up and down directions. The mounting plate 11 is connected to a fender apron upper 13 through its top, and a rear lower member 15 is connected to the rear end portion of the front side member 10.

The sub-frame 20 is mounted on the front and rear lower portions of the front side member 10 through a plurality of mounting portions, for example, four vehicle body mounting portions 21a, 21b, 21c, and 21d.

The sub-frame 20 includes a frame main body 23 and a longitudinal member 25.

The frame main body 23 is provided as a main body in which an upper plate and a lower plate are joined, and lower arms of the front suspension (not shown in the drawing) are connected to both sides of the frame main body 23. The frame main body 23 is mounted under the rear portion of the front side member 10.

This frame main body 23 is located in the lower rear of the front side member 10 through two vehicle body mounting portions 21c, and 21d provided on both rear sides of the four vehicle body mounting portions 21a, 21b, 21c, 21d.

The longitudinal member 25 may be formed extending from both front end portions of the frame main body 23 to both front end portions of the front side member 10. The longitudinal member 25 is connected to each of the two front end portions of the frame main body 23 through the rear end portion.

The longitudinal member 25 is connected to the front end side of the front side member 10 through its front end portion. The front end portion of the longitudinal member 25 is connected to the lower portion of the mounting plate 11.

The longitudinal member 25 may be mounted to the lower portion of the mounting plate 11 through two points of vehicle body mounting portions 21a and 21b provided on the front end side of the four vehicle body mounting portions 21a, 21b, 21c, 21d.

Accordingly, the sub-frame 20 configured as described above may be provided in a C-type having the longitudinal member 25 extending from both front end portions of the frame main body 23 to both front end portions of the front side member 10.

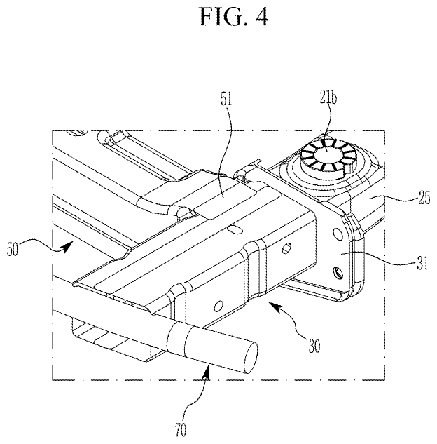

FIG. 4 is a drawing showing a lower crush box applicable to a front structure of a vehicle body according to various exemplary embodiments of the present invention.

Referring to FIG. 1, FIG. 2, FIG. 3, and FIG. 4, in various exemplary embodiments of the present invention, the lower crush box 30 absorbs the impact while compressing and deforming by the front impact of the vehicle, and is connected to both front end portions of the sub-frame 20 along the vehicle body length direction.

The lower crush box 30 may be formed as a box type with a closed space, and is connected to the front end portion of the longitudinal member 25 of the sub-frame 20 through a stay bracket 31 along the vehicle body length direction.

The lower crush box 30 is connected to the stay bracket 31 through a rear end portion thereof, and the stay bracket 31 is connected to a front mount surface of the longitudinal member 25. The stay bracket 31 may be bolted to the front mount surface of the longitudinal member 25. For example, the stay bracket 31 may be bolted to the front mount surface of the longitudinal member 25 through a three-point stay mounting portion 33.

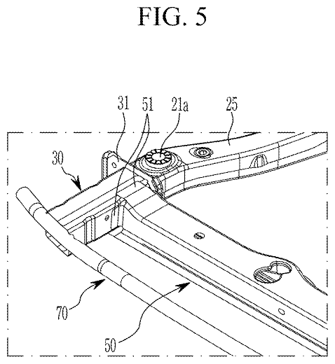

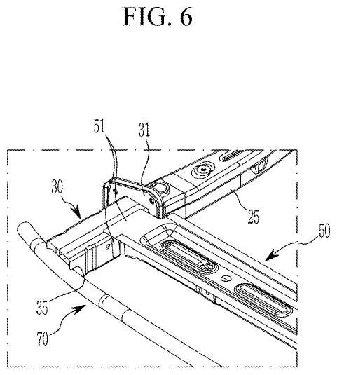

FIG. 5 and FIG. 6 is a drawing showing the connecting structure of a radiator support lower member applicable to a front structure of a vehicle body according to various exemplary embodiments of the present invention.

Referring to FIG. 5 to FIG. 6, in various exemplary embodiments of the present invention, the radiator support lower member 50 is to support a cooling module including a radiator in front of the vehicle body, and is connected to the lower crush box 30 along the vehicle width direction thereof.

The radiator support lower member 50 may be formed to have a closed cross-section, and is coupled to the lower crush box 30 along the vehicle width direction through both end portions thereof. Accordingly, connecting flange portions 51 that are joined to the lower crush box 30 are formed at both end portions of the radiator support lower member 50 along the vehicle width direction thereof.

As an alternative, a separate mounting bracket (not shown in the drawing) for mounting the cooling module may be attached to the upper portion of the radiator support lower member 50.

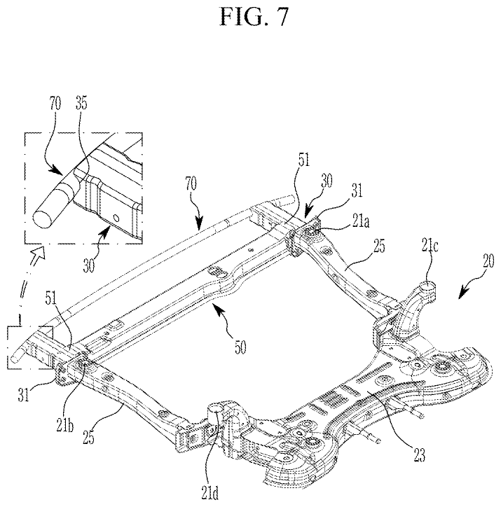

FIG. 7 is a drawing showing the connecting structure of a lower stiffener applicable to a front structure of a vehicle body according to various exemplary embodiments of the present invention.

Referring to FIG. 7, in various exemplary embodiments of the present invention, the lower stiffener 70 is for minimization of injuries of a pedestrian when colliding with a pedestrian, and is spaced from the front side of the radiator support lower member 50 along the vehicle width direction thereof.

The lower stiffener 70 is provided in a form of a pipe, and connected to the front end portion of the lower crush box 30 along the vehicle width direction thereof. The lower stiffener 70 is connected to a mount groove 35 with round shape provided at the front end portion of the lower crush box 30, and may be welded, for example.

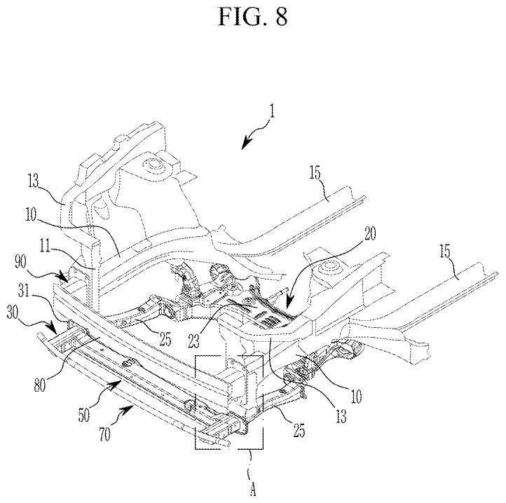

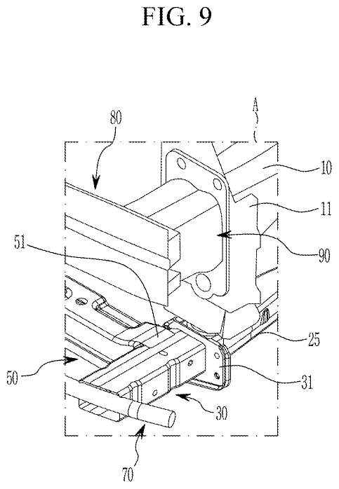

FIG. 8 is a drawing showing the connecting structure of a back beam applicable to a front structure of a vehicle body according to various exemplary embodiments of the present invention and FIG. 9 is an enlarged view of a part one of FIG. 8.

FIG. 8 and referring to FIG. 9, in various exemplary embodiments of the present invention, the back beam 80 is for mounting the bumper unit, and is connected to the front side of the front side member 10 along the vehicle width direction thereof.

The back beam 80 is connected to the mounting plate 11 through an upper crush box 90 corresponding to the front end portion of the front side member 10. The upper crush box 90 absorbs the impact while compressing and deforming by the impact when the vehicle collides in front, and connects the mounting plate 11 on the front side of the front side member 10 and the back beam 80.

In the front structure 100 of the vehicle body 1 according to various exemplary embodiments of the present invention, the lower stiffener 70, the lower crush box 30 and the longitudinal members 25 of the sub-frame 20 have a structure connected to each other along the vehicle body length direction.

Furthermore, as shown in FIG. 3, in the front structure 100 of the vehicle body 1 according to various exemplary embodiments of the present invention, a first load path 101, a second load path 102, and a third load path 103 are formed to facilitate dispersion of collision energy according to a vehicle's forward collision.

The first load path 101 connects the back beam 80 and the front side member 10 through the upper crush box 90. The second load path 102 connects the lower stiffener 70 and the longitudinal member 25 of the sub-frame 20 through the lower crush box 30. and the third load path 103 connects the first load path 101 and the second load path 102 in up and down directions of the vehicle body through the mounting plate 11.

That is, in various exemplary embodiments of the present invention, an H-type load path may be configured through the first, second, and third load paths 101, 102, and 103 on the front side of the vehicle body.

As an alternative, in various exemplary embodiments of the present invention, other parts may additionally combined between the first and second load paths 101 and 102 described above, and the first load path 101 and the second load path 102 may be connected in up and down directions through a separate fourth load path (not shown in the drawing). In the instant case, a load path shaped as #-type may be configured through the first, second, and third load paths 101, 102, and 103 and the fourth load path on the front side of the vehicle body.

Hereinafter, the operation of the front structure of the vehicle body 100 according to various exemplary embodiments of the present invention configured as described above will be described with reference to the drawings included above.

In various exemplary embodiments of the present invention, the lower stiffener 70 and the longitudinal member 25 of the sub-frame 20 are connected to through the lower crush box 30. Furthermore, in various exemplary embodiments of the present invention, the back beam 80 and the front side member 10 are connected to through the upper crush box 90.

Therefore, in various exemplary embodiments of the present invention, collision energy may be distributed through the back beam 80, the upper crush box 90 and the lower crush box 70 when the vehicle is in a frontal collision.

Furthermore, in various exemplary embodiments of the present invention, in the case of a frontal collision of the vehicle, the lower stiffener 70 may secure the supporting force in the width direction of the vehicle, and the lower stiffener 70 induces the deformation of the lower crush box 30 while the impact force may be absorbed by transferring to the sub-frame 20.

Furthermore, in various exemplary embodiments of the present invention, when a vehicle collides in the front, the sub-frame 20 is separated with the engine and the longitudinal member 25 of the sub-frame 20 is deformed to absorb collision energy.

Accordingly, in various exemplary embodiments of the present invention, collision energy may be effectively distributed through load paths in various directions in the vehicle body of a short overhang compact/small vehicle, and front collision safety may be secured.

On the other hand, in various exemplary embodiments of the present invention, the radiator support lower member 50 may replace the role of the transverse direction member of the sub-frame 20, reducing manufacturing cost and weight.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A front structure of a vehicle body, the front structure comprising:
a sub-frame mounted on a front side member through a mounting plate;
a lower crush box connected to each front portion of the sub-frame along a vehicle body length direction;
a radiator support lower member connected to the lower crush box along a vehicle width direction; and
a lower stiffener connected to a front portion of the lower crush box along the vehicle width direction.

2. The front structure of claim 1, wherein the sub-frame includes:
a frame main body connected to a rear portion of the front side member; and
a longitudinal member connected to a front portion of the frame main body and connected to a front portion of the front side member.

3. The front structure of claim 2,
wherein the mounting plate is connected to the front portion of the front side member along up and down directions of the vehicle body, and
wherein a front portion of the longitudinal member is connected to a lower portion of the mounting plate.

4. The front structure of claim 2, wherein the lower crush box is connected to the front portion of the longitudinal member along the vehicle body length direction through a stay bracket.

5. The front structure of claim 4, wherein the stay bracket is connected to the front portion of the longitudinal member through a stay mounting portion.

6. The front structure of claim 1, wherein the radiator support lower member includes a connecting flange portion connected to the lower crush box at first and second end portions of the radiator support lower member along the vehicle width direction.

7. The front structure of claim 1, wherein the lower stiffener is connected to a mount groove formed at the front portion of the lower crush box.

8. The front structure of claim 1, wherein the lower stiffener, the lower crush box and the sub-frame are connected to each other along the vehicle body length direction.

9. The front structure of claim 1, further includes a back beam connected to a front portion of the front side member along the vehicle width direction through an upper crush box.

10. The front structure of claim 9, including:
a first load path that connects the back beam and the front side member through the upper crush box;
a second load path that connects the lower stiffener and the sub-frame through the lower crush box; and
a third load path that connects the first load path and the second load path in up and down directions of the vehicle body through the mounting plate connected to the front portion of the front side member.

11. A front structure of a vehicle body, the front structure comprising:
front side members provided on a first side and a second side of the vehicle body, respectively, in a vehicle body length direction;
mounting plates, wherein an upper portion of each mounting plate is connected to a front portion of each front side member;
a back beam connected to the mounting plates on the first side and the second side of the vehicle body;
a sub-frame including:
a frame main body which is connected to a rear portion of each front side member; and
longitudinal members, each of which is provided on first and second front portions of the frame main body, respectively and connected to a lower portion of each mounting plate, respectively;
lower crush boxes connected to first and second front portions of the sub-frame; and
a radiator support lower member connected to each of the lower crush boxes.

12. The front structure of claim 11, further includes a lower stiffener which is connected to each of the lower crush boxes.

13. The front structure of claim 12, wherein the lower stiffener is connected to a mount groove formed at a front portion of the lower crush boxes.

14. The front structure of claim 11,
wherein each of the mounting plates is connected to a front portion of each front side member along up and down directions of the vehicle body, and
wherein a front portion of each longitudinal member is connected to a lower portion of each mounting plate, respectively.

15. The front structure of claim 11, wherein the lower crush boxes are connected to front portions of the longitudinal members along the vehicle body length direction through a stay bracket.

16. The front structure of claim 15, wherein the stay bracket is connected to the front portions of the longitudinal members through a stay mounting portion.

17. The front structure of claim 11, wherein the radiator support lower member includes a connecting flange portion connected to the lower crush boxes at first and second end portions of the radiator support lower member along a vehicle width direction.
